(19) United States
(12) Patent Application Publication
(10) Pub. No.: US 2002/0142635 A1
(43) Pub. Date: Oct. 3, 2002

(54) Motherboard with built-in sound effect and the relative analog input/output port connector

(76) Inventor: Benjamin Ym Pan, Taipei Hsien (TW)

Correspondence Address: J.C. Patents, Inc., Suite 250, 4 Venture, Irvine, CA, 92618, US

(21) Appl. No.: 09/990,915

(22) Filed: Nov. 13, 2001

Related U.S. Application Data
(60) Provisional application No. 60/279,549, filed on Mar. 28, 2001.

(30) Foreign Application Priority Data
Jun. 13, 2001 (TW) 90114253

(51) Int. Cl. H01R 4/66

(52) U.S. Cl. 439/101

(57) ABSTRACT

A motherboard with built-in sound effect, having a plurality of circuit devices, a printed circuit board, and an analog input/output (I/O) port connector. The circuit devices are used to provide circuit functions to the motherboard. The printed circuit board is used to carry the circuit devices and provide a circuit for connecting the circuit devices. The analog I/O port connector is used to provide an I/O analog audio signal. The analog I/O port connector has been specially designed.

### CROSS-REFERENCE TO RELATED APPLICATION

This application claims the priority benefit of U.S.A provisional application serial No. 60/279,549, filed Mar. 28, 2001, and Taiwan application serial no. 90114253, filed Jun. 13, 2001.

### BACKGROUND OF THE INVENTION

1. Field of the Invention

The invention relates in general to a motherboard, and more particularly, to a motherboard with a built-in sound effect.

2. Description of the Related Art

In the early motherboard, require insertion of a sound card to allow a user to listen to music, which is inconvenient. Some motherboard manufacturers thus incorporate soundeffects into the motherboard. However, in the prior art, the analog input/output (I/O) port connector is not separated from the digital I/O port connector. The peak-to-peak voltage for the power source of the analog I/O port connector is normally 3 to 5 V, but the maximum supplied peak-to-peak voltage for the digital I/O port connector is only 1 V. In addition, the analog signal is more sensitive with a frequency much higher than that of the digital signal. Mutual interference of radiation and signal thus occur to affect the audio quality. Moreover, the built-in sound effect of the conventional design has only two audio channels, which do not provide good sounds.

Without an ideal design, the user often makes a mistake while plugging the analog I/O port and either blows the speaker or crashes the computer system.

### SUMMARY OF THE INVENTION

The invention provides a motherboard with a built-in six-audio-channel sound effect, of which the analog I/O port connector is specially designed to effectively improve the radiation and signal interference. The problems that cause the speaker to blow and the system to crash in the prior art are resolved.

The motherboard with a built-in six-audio-channel sound effect comprises a plurality of circuit devices, a printed circuit board and an analog I/O port connector. The circuit devices are used to provide circuit functionality to the motherboard. The printed circuit board is used to carry the circuit devices and to provide a circuit for connecting the circuit devices. The analog I/O port connector is used to provide the I/O analog audio signal.

The invention further provides an analog I/O port connector used for sound effect. The analog I/O port connector is applied to a motherboard. The analog I/O port connector includes a plurality of I/O pins divided into two rows. The I/O pins comprise at least a plurality of first analog source pins, a plurality of second source pins, a plurality of analog ground pins, two linear pins, two surrounding pins, a heavy base pin and a central pin. The first and second analog source pins are diagonally symmetric positioned. The analog ground pins are arranged in diagonal symmetry. The linear pins and the surrounding pins are arranged in diagonal symmetry. The heavy base pin and the central pin are also diagonally symmetrically arranged.

In one embodiment of the invention, the I/O pins of the audio analog I/O port connector used in the motherboard with built-in sound effect include: 1: 5V analog source pin 2: left channel linear pin 3: right channel surrounding pin 4: central pin 5: analog ground pin 6: analog ground pin 7: analog ground pin 8: 3.3V analog source pin 9: 3.3V analog source pine 10: analog ground pin 11: analog ground pin 12: analog ground pin 13: heavy base pin 14: right channel linear pin 15: left channel surrounding pin 16: 5V analog source pin

Therefore, the invention provides a motherboard with six audio channels sound effect. The I/O port connector of the motherboard is specially designed, so that the drawbacks of the prior art are reduced.

Both the foregoing general description and the following detailed description are exemplary and explanatory only and are not restrictive of the invention, as claimed.

### BRIEF DESCRIPTION OF THE DRAWINGS

FIG. 1 shows pins arrangement of the analog I/O port connector in one embodiment of the invention.

### DESCRIPTION OF THE PREFERRED EMBODIMENTS

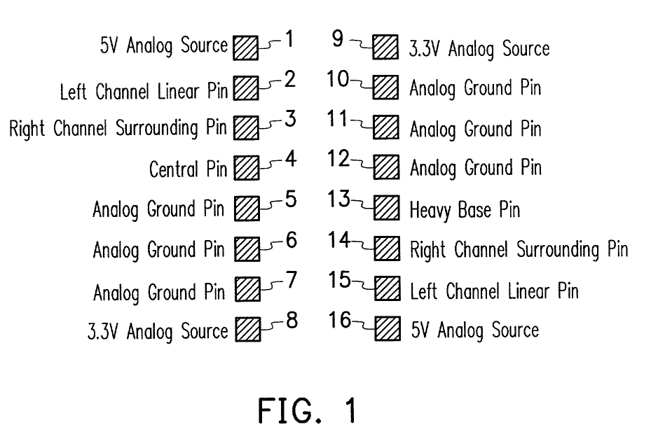

In FIG. 1, the pins arrangement of the analog I/O port connector in one embodiment of the invention.

The invention provides a motherboard with a built-in six-audio-channel sound effect. The motherboard has a central processing unit, a chip set, six audio channel, etc. The above structures are the circuit devices that provide the circuit functions to the motherboard. The motherboard further has a printed circuit board for carrying the circuit devices and to provide the circuit for connecting the above circuit devices, and an analog I/O port connector that provides the I/O analog audio signal, that is, the I/O analog signal for sound effect.

As shown in FIG. 1, the I/O port connector used to support six audio channels is applied to the motherboard. The analog I/O port connector has 16 pins arranged in two rows. The first row of the I/O pins is defined as 1 to 8, while the second row of the I/O pins is defined from 9-16 as: 1: 5V analog source pin 2: left channel linear pin 3: right channel surrounding pin 4: central pin 5: analog ground pin 6: analog ground pin 7: analog ground pin 8: 3.3V analog source pin 9: 3.3V analog source pine 10: analog ground pin 11: analog ground pin 12: analog ground pin 13: heavy base pin 14: right channel linear pin 15: left channel surrounding pin 16: 5V analog source pin

Two 5V analog source pins are symmetrically and diagonally positioned to each other, as shown as the pin 1 and pin 16. Two 3.3V analog source pins are also symmetrically and diagonally positioned with each other, as shown as the pin 8 and pin 9. Six analog ground pins are symmetrically and diagonally located as the pins 5, 6, 7 and 10, 11, 12. The left audio channel linear pin is symmetric and diagonal to the left audio channel surrounding pin as pins 2 and 15, while the right audio channel linear pin is symmetric and diagonal to the right audio channel surrounding pin as pins 3 and 14. The heavy base pin 4 and the central pin 13 are also symmetric and diagonal to each other in position.

The so-called symmetric and diagonal arrangement in the above embodiment is explained as follows. The analog I/O port connector has 16 pins. Pin 1 is symmetric and diagonal to pin 16. Pin 2 is symmetric and diagonal to pin 15. Pin 3 is symmetric and diagonal to pin 14. Similarly, when the analog I/O port connector has 20 pins, pin 1 is symmetric and diagonal to pin 20. Pin 2 is symmetric and diagonal to pin 19, and pin 3 is symmetric and diagonal to pin 18, etc.

By designing the pins of the analog I/O port connector as above, if the speaker is plugged in the opposite way, it will not blow, and the system will not crash. Instead, the speaker is reversed to warn the user.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. An analog I/O port connector used for sound effect of a motherboard, comprising a plurality of I/O pins arranged in two rows, wherein the 1/0 pins include:
a plurality of first analog source pins, diagonally and symmetrically positioned;
a plurality of second analog source pins, diagonally and symmetrically positioned;
a plurality of ground pins, diagonally and symmetrically positioned;
two linear pins;
two surrounding pins, diagonal and symmetrical to the linear pins in position;
one heavy base pin; and
one central pin, diagonal and symmetrical to the heavy base pin in position.

2. The analog I/O port connector according to claim 1, comprising 16 of the I/O pins.

3. The analog I/O port connector according to claim 2, wherein the I/O pins in the first row are defined as 1 to 8, while the I/O pins in the second row are defined as 9 to 16, and the relative positions are: 1: 5V analog source pin 2: left channel linear pin 3: right channel surrounding pin 4: central pin 5: analog ground pin 6: analog ground pin 7: analog ground pin 8: 3.3V analog source pin 9: 3.3V analog source pine 10: analog ground pin 11: analog ground pin 12: analog ground pin 13: heavy base pin 14: right channel linear pin 15: left channel surrounding pin 16: 5V analog source pin.

4. The analog I/O port connector according to claim 1, wherein the first analog source pins include 5V analog source pins.

5. The analog I/O port connector according to claim 1, wherein the second analog source pins include 3.3V analog source pins.

6. The analog I/O port connector according to claim 1, wherein the linear pins include a left audio channel linear pin and a right audio channel linear pin.

7. The analog I/O port connector according to claim 1, wherein the surrounding pins include a left audio channel surrounding pin and a right audio channel surrounding pin.

8. A motherboard with built-in sound effect, comprising at least:
a plurality of circuit devices, to provide the motherboard a sound effect;
a printed circuit, to carry the circuit devices and the provide a connection path to the circuit devices; and
an analog I/O port connector, to provide an I/O analog signal to the sound effect, the I/O pins include:
a plurality of first analog source pins, diagonally and symmetrically positioned;
a plurality of second analog source pins, diagonally and symmetrically positioned;
a plurality of ground pins, diagonally and symmetrically positioned; two linear pins;
two surrounding pins, diagonal and symmetrical to the linear pins in position;
one heavy base pin; and
one central pin, diagonal and symmetrical to the heavy base pin in position.

9. The motherboard according to claim 8, comprising 16 of the I/O pins.

10. The motherboard according to claim 8, wherein the I/O pins in the first row are defined as 1 to 8, while the I/O pins in the second row are defined as 9 to 16, and the relative positions are: 1: 5V analog source pin 2: left channel linear pin 3: right channel surrounding pin 4: central pin 5: analog ground pin 6: analog ground pin 7: analog ground pin 8: 3.3V analog source pin 9: 3.3V analog source pine 10: analog ground pin 11: analog ground pin 12: analog ground pin 13: heavy base pin 14: right channel linear pin 15: left channel surrounding pin 16: 5V analog source pin.
